(19) United States
(12) Patent Application Publication
(10) Pub. No.: US 2007/0256773 A1
(43) Pub. Date: Nov. 8, 2007

(54) Cool transfer wireless RF identification label

(76) Inventor: Fu-Nan Huang, Kaohsiung City (TW)

Correspondence Address: Fu-Nan Huang, 235 Chung - Ho, Box 8-24, Taipei, TW

(21) Appl. No.: 11/416,441

(22) Filed: May 3, 2006

(51) Int. Cl. B31B 1/60; G08B 13/14; H01Q 17/00

(52) U.S. Cl. 156/60; 340/572.7; 29/601

(57) ABSTRACT

A cool transfer wireless RF identification label comprises a carrier; a semiconductor chip having a memory; an antenna attached to the semiconductor chip wherein data in the memory is transferred from the antenna; a metal foil on the antenna; the metal foil containing adhesive for cool-transferring the metal foil to the carrier. The carrier is a paper and a cover paper is covered thereon as a shield. The cover paper has a through hole for filling gel so that the cover paper is adhered to the carrier. The carrier is a soft film. The film is a PET film. The gel is a water solvable gel for combining the adhesive of the metal foil to the carrier. The antenna is printed upon the carrier by lithographic printing.

### FIELD OF THE INVENTION

The present invention relates to labels, and in particular to a cool transfer wireless RF identification label, wherein wireless electromagnetic wave is used to transfer data in a memory of a label. By the present invention, the problems that the generation of conductive ink in heating and the sublimation of the metal foil in the manufacturing process are avoided. Thus the health of the workers are retained.

### BACKGROUND OF THE INVENTION

The radio frequency identification (RFID) is new technology, in that a carrier of a label (a tag, a label) is adhered with an IC chip and an antenna. In general, the carrier is a heat-tolerant and soft film (such as a PET film). The RFID label is adhered on goods. Then the RF signals are received by a receiver and then are identified by the identification software so as to derive the information about the goods. The technology is widely used in identification of goods and persons. It is especially advantageous in accounting.

In this technology, the antenna is formed by etching or cutting copper or aluminum foils, or is made of conductive ink which is a conductive compound material. That is, a great number of conductive particles (for example silver particles called as silver glue) are added to the conductive ink. Then the ink is solidified and dried.

In one prior art, a heat transfer wireless RF label is developed. The main feature is that the label has an antenna made of conductive metal foils, a wireless RF antenna substrate which is a flat sheet, an antennal on the RF antenna substrate, a wireless RF chip placed upon the substrate.

However, in heat transfer, the conductive medium of the metal foil must be printed upon a carrier. That is, in heat transfer process, the conductive medium is heated and pressed to the heat tolerant film (such as PET, that is a carrier). Generally, the temperature for heat transfer is about 170-200° C. with proper time control and area control for the printed pattern. The coating layer, ink, paper, environmental temperature, wetness will affect the transfer result. Moreover in the heat transfer process, chemical volatile gas will generate. This is a problem in environmental protection. Further, heat and heat source will increase the cost in manufacturing. Moreover the process is tedious and time consumed.

### SUMMARY OF THE INVENTION

Accordingly, the primary object of the present invention is to provide a cool transfer wireless RF identification label, wherein problems that the generation of conductive ink in heating and the sublimation of the metal foil in the manufacturing process are avoided. Thus the health of the workers are retained.

To achieve above objects, the present invention provides a cool transfer wireless RF identification label which comprises a carrier; a semiconductor chip having a memory; wherein data in the memory is transferred from the antenna; an antenna attached to the semiconductor chip; a metal foil on the antenna; the metal foil containing adhesive for cool-transferring the metal foil to the carrier. The carrier is a paper and a cover paper is covered thereon as a shield. The cover paper has a through hole for filling gel so that the cover paper is adhered to the carrier. The carrier is a soft film. The film is a PET film. The gel is a water solvable gel for combining the adhesive of the metal foil to the carrier. The antenna is printed upon the carrier by lithographic printing.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a perspective view of the present invention.

FIG. 3 shows the flow diagram of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

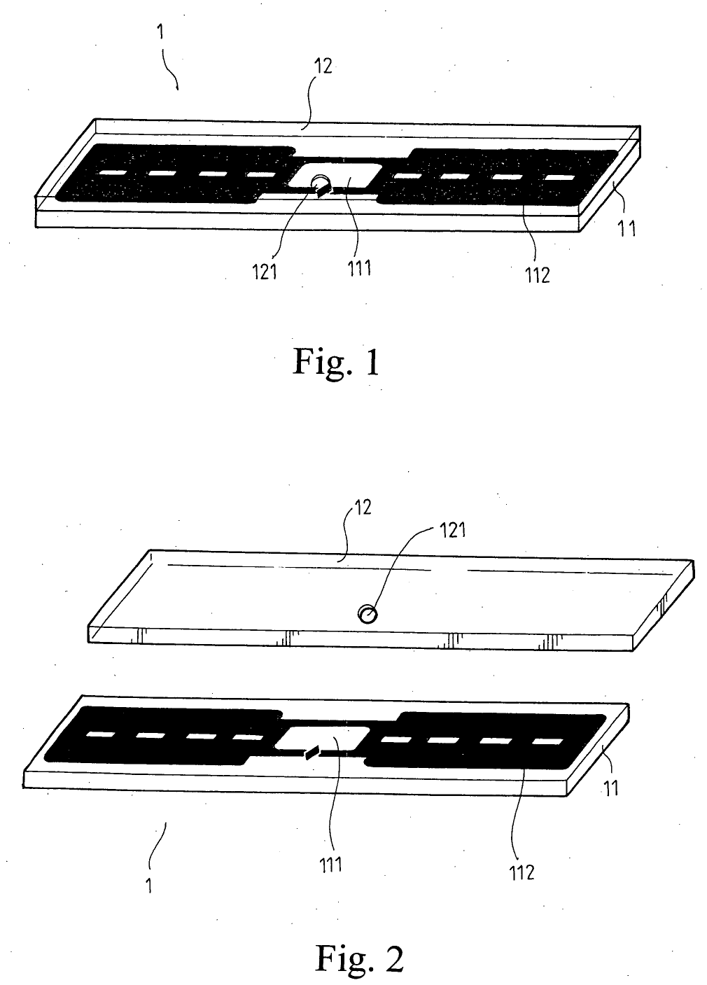

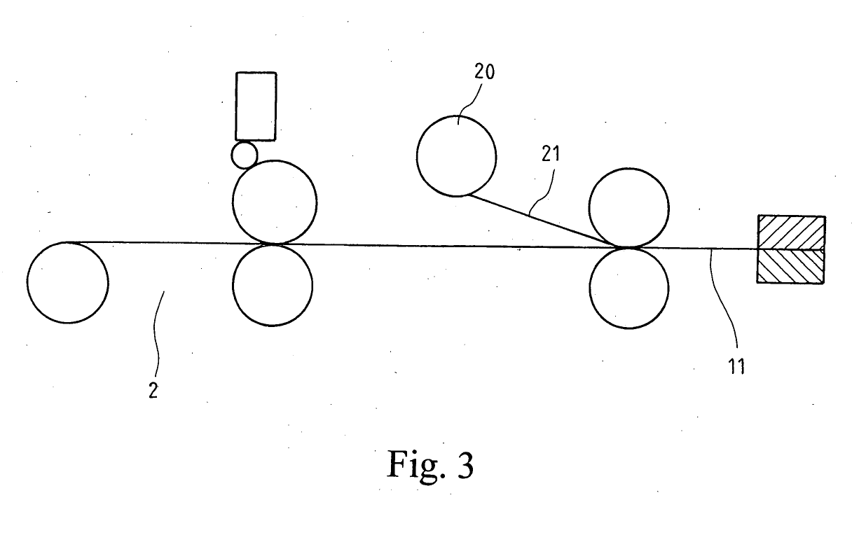

Referring to FIGS. 1 and 3, the present invention relates to cool transfer wireless RF identification labels (which are tags, or labels). The present invention has the following elements.

A carrier 11 may be a paper. The present invention can be directly made on a label paper. Thus it is unnecessary to make the present invention into a film carrier and then adhere the film carrier to an object. The carrier 11 can be covered by a cover paper 12 as a shield in package. A through hole 121 is formed on the cover paper 12. Gel is filled into the through hole 121 so that the carrier 11 is adhered to the cover paper 12 as an integral body which can be used as a label paper. Furthermore, in the present invention, the carrier 11 may be a film (such as a PET film) or other soft and thin sheets. Then film and sheets can be implanted to an object for identification.

A semiconductor chip 111 is installed on the carrier 11. The semiconductor chip 111 has a memory. The semiconductor chip 111 is combined to an antenna 112. The antenna 112 has a metal foil. The data in the memory is transferred through the antenna 112. In the present invention, the metal foil has adhesive which may be a water soluable adhesive. Thereby a film layer of the metal foil is adhered to a surface of the carrier 11 by lithographic printing. Thus, thus the metal foil is cool-transferred to the carrier 11.

In the present invention, the metal foil has adhesive. The adhesive causes that the metal foil can be cool transferred to the carrier 11. The environment pollution from the volatile chemical gas in heating of the metal foil is avoided. No heater is used. The cost is low. The process is easy.

In the present invention, the metal foil is made of minor conductive particles or other special material (such as conductive polymers, etc.), which has the advantage of receiving wireless signals used in RFID.

Referring to FIG. 3, the flow diagram of the present invention is illustrated. In the present invention, the transfer belt 2 has a plurality of rollers 20 for transferring a carrier 11 which is a paper in this embodiment. Then an adhesive paper 21 (with water soluble adhesive) is covered upon the carrier 11. The adhesive paper 21 is coated with a layer of metal foil. Thus, the metal foil is transferred and thus printed on the carrier 11 so as to form as a conductive antenna 112. Then, the semiconductor chip 111 with a memory is adhered on the carrier 11 and is combined to the antenna 112.

In use, the RFID label is adhered on an object to be identified, for example a merchandise. Then a reader is used to identify the object by the metal foil. Thus, the costs in identification, counting and accounting are saved. Thereby the work is reduced greatly and the cost is also reduced.

Furthermore, in the present invention, the problems that the generation of conductive ink in heating and the sublimation of the metal foil in the manufacturing process are avoided. Thus the health of the workers is retained.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A cool transfer wireless RF identification label comprising:
a carrier;
a semiconductor chip having a memory;
an antenna attached to the semiconductor chip; wherein data in the memory is emitted out from the antenna; and
a metal foil on the antenna; the metal foil containing adhesive for cool-transferring the metal foil to the carrier.

2. The cool transfer wireless RF identification label as claimed in claim 1, wherein the carrier is a paper and a cover paper is covered thereon as a shield; and the cover paper has a through hole for filling gel so that the cover paper is adhered to the carrier.

3. The cool transfer wireless RF identification label as claimed in claim 1, wherein the carrier is a soft film.

4. The cool transfer wireless RF identification label as claimed in claim 3, wherein the film is a PET film.

5. The cool transfer wireless RF identification label as claimed in claim 1, wherein the gel is a water solvable gel for combining the adhesive of the metal foil to the carrier.

6. The cool transfer wireless RF identification label as claimed in claim 1, wherein the antenna is printed upon the carrier by lithographic printing.
